(19) United States
(12) Patent Application Publication
(10) Pub. No.: US 2005/0094070 A1
(43) Pub. Date: May 5, 2005

(54) Liquid crystal display with a planarization layer having black resin

(75) Inventors: Chien-Ting Lai, Miao-Li (TW); Jia-Pang Pang, Miao-Li (TW); Yung Chang Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 10/979,930

(22) Filed: Nov. 1, 2004

(30) Foreign Application Priority Data
Nov. 4, 2003 (TW) 92130738

(51) Int. Cl. G02F 1/1333

(52) U.S. Cl. 349/122

(57) ABSTRACT

A liquid crystal display (LCD) (2) includes an upper substrate (201), a lower substrate (202), and a liquid crystal layer (208) interposed between the substrates. The upper substrate has a color filter (216). A planarization layer (204) and a reflection electrode (217) are disposed on the lower substrate. The planarization layer is made of a black resin. An adhesive frame (215) for conglutinating the substrates is disposed therebetween. The reflection layer has gaps therein, the gaps defining non-display areas. Parts of the planarization layer corresponding to the non-display areas absorb light beams leaked from the non-display areas. These parts of the planarization layer perform the function of a black matrix. Because the black matrix is provided on the lower substrate, light beams used to solidify the adhesive frame during manufacturing of the LCD are not obstructed. Thus the LCD has enhanced sealing and is more durable and reliable.

### BACKGROUND OF THE INVENTION

1. Field of the Invention

The present invention relates to a liquid crystal display utilizing a planarization layer having black resin to avoid light leakage.

2. Description of Prior Art

A black matrix is used in many display apparatuses in order to absorb undesired light beams. In many liquid crystal displays, the black matrix is a coating of black chromium oxide on a display substrate. The black chromium oxide has a high optical density, and effectively blocks the transmission of light beams. However, the black chromium oxide typically forms a metallic surface having a higher reflectivity. A black matrix made of black chromium oxide generates undesired reflections and causes the contrast ratio of the liquid crystal display to be reduced. A black matrix of resin has been suggested as an alternative to black chromium oxide. The resin has a high optical density and a low reflectivity. In transmission type liquid crystal displays, a black matrix is typically combined with a color filter to form a color filter substrate.

U.S. Pat. No. 6,342,935 issued on Jan. 29, 2002 discloses a reflective type liquid crystal display. Referring to FIG. 5, the reflective type liquid crystal display 1 comprises an upper substrate 101, a lower substrate 102, and a liquid crystal layer 108 interposed therebetween. The upper substrate 101 has a color filter layer 116, a transparent electrode 112 and an upper alignment layer 110 disposed at an inner surface thereof. The color filter layer 116 comprises a color filter 116a, and a black matrix 116b disposed in spaces around the color filter 116a. The lower substrate 102 has an organic insulation film 104 and a lower alignment film 106. A reflection electrode 114 with bumps is provided on the insulation film 104. An adhesive frame (not shown) is disposed between corresponding edges of the substrates 101 and 102. When the frame is exposed to ultraviolet irradiation, it solidifies and seals the substrates 101 and 102.

Light beams from the external environment pass through the upper substrate 101 and the liquid crystal layer 108 and reach the reflection electrode 114. The bumps of the reflection electrode 114 reflect and disperse the light beams back toward the external environment, such that light beams having a uniform distribution emit from the upper substrate 101.

The color filter 116a usually comprises separate colored sections containing red, green and blue pigment respectively. The black matrix 116b is formed in gaps between the colored sections, and blocks transmission of light between the colored sections. Thus the black matrix 116b prevents leakage of light from the color filter 116a, and increases the contrast ratio of the liquid crystal display 1. However, during the process of sealing the frame between the substrates 101, 102, the black matrix 116b is liable to obstruct the ultraviolet light beams. This results in faulty solidification of parts of the frame, and can lead to premature failure of the sealing. In addition, because of the need for the black matrix 116b, the color filter layer 116 is relatively expensive. This inflates the cost of the liquid crystal display 1.

It is desired to provide a liquid crystal display which overcomes the above-described problems.

### SUMMARY OF THE INVENTION

An object of the present invention is to provide a liquid crystal display which has enhanced sealing between substrates thereof, which is durable and reliable, and which is relatively inexpensive.

A liquid crystal display of the present invention comprises an upper substrate, a lower substrate, and a liquid crystal layer interposed between the upper and lower substrates. The upper substrate has a color filter. A planarization layer and a reflection electrode are disposed on the lower substrate in that order from top to bottom. The planarization layer is made of a black resin. An adhesive frame for conglutinating the substrates is disposed between corresponding edges of inner surfaces of the substrates.

The reflection electrode has gaps therein, the gaps defining non-display areas. Parts of the planarization layer corresponding to the non-display areas absorb light beams leaked from the non-display areas. That is, these parts of the planarization layer perform the function of a black matrix. Therefore the liquid crystal display does not need a black matrix for the color filter. In addition, because the black matrix is provided on the lower substrate, light beams used to solidify the adhesive frame during manufacturing of the liquid crystal display are not obstructed. As a result, the liquid crystal display has enhanced sealing and is more durable and reliable.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, simplified, side cross-sectional view of a liquid crystal display according to a first embodiment of the present invention;

FIG. 2 is a schematic, simplified, side cross-sectional view of a liquid crystal display according to a second embodiment of the present invention;

FIG. 3 is a schematic, simplified, side cross-sectional view of a liquid crystal display according to a third embodiment of the present invention;

FIG. 4 is a schematic, simplified, side cross-sectional view of a liquid crystal display according to a fourth embodiment of the present invention; and

FIG. 5 is a schematic, side cross-sectional view of part of a conventional liquid crystal display.

### DETAILED DESCRIPTION OF THE INVENTION

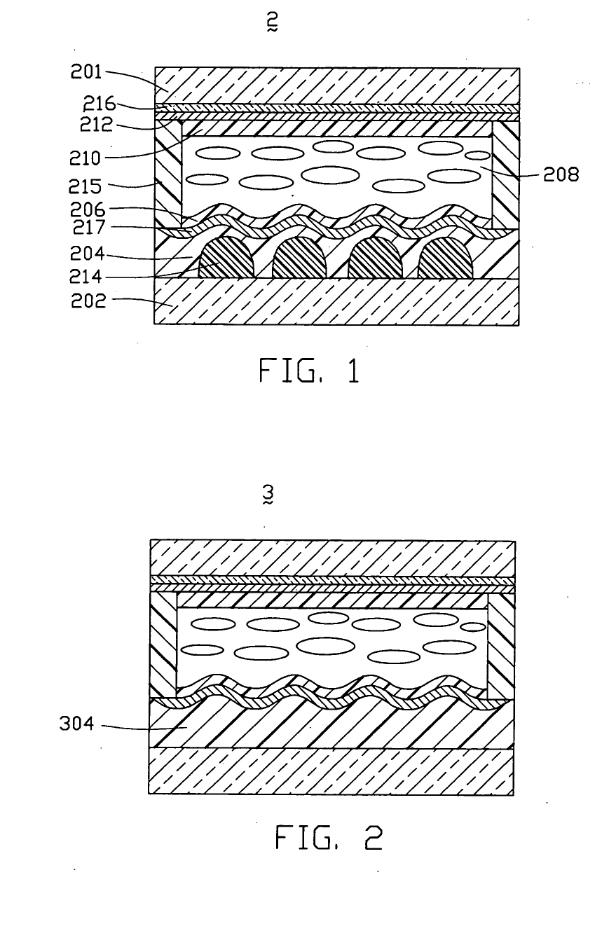

Referring to FIG. 1, a liquid crystal display 2 according to the first embodiment of the present invention is shown. The liquid crystal display 2 comprises an upper substrate 201, a lower substrate 202, and a liquid crystal layer 208 interposed between the substrates 201, 202. A color filter 216, a transparent electrode 212 and an upper alignment film 210 are disposed on an underside of the upper substrate 201, in that order from top to bottom. A plurality of protrusions 214 is formed on the lower substrate 201. A planarization layer 204, a reflection electrode 217 and a lower alignment film 206 are disposed on the lower substrate 202 and the protrusions 204, in that order from bottom to top. An adhesive frame 215 for conglutinating the substrates 201 and 202 is disposed between corresponding edges of inner surfaces of the substrates 201 and 202.

The planarization layer 204 is formed on the protrusions 214 and the lower substrate 201, and therefore has a bumpy upper surface. The reflection electrode 217 is formed on the planarization layer 204 by a combination of a deposition process and a photo mask process, and forms a plurality of bumps (not labeled) due to the bumpy shape of the planarization layer 204. When light beams from the external environment above the liquid crystal display 2 reach the electrode 217, the bumps of the electrode 217 help generate uniform reflection of the light beams. To enhance the efficiency of utilization of the external source light beams, the reflection electrode 217 comprises a high reflectivity material such as silver or aluminum.

The reflection electrode 217 does not cover the entire planarization layer 204. That is, there are gaps in the reflection electrode 217, which are known as non-display areas. These non-display areas correspond to gaps between colored sections of the color filter 216. The planarization layer 204 is made of a black resin. Therefore the planarization layer 204 absorbs light beams leaked from the non-display areas. That is, part of the planarization layer 204 functions like and effectively forms a black matrix. Therefore the liquid crystal display 2 does not need a black matrix combined with the color filter 216, which reduces costs. In addition, because there is no black matrix at the upper substrate 201, light beams used to solidify the adhesive frame 215 during manufacturing of the liquid crystal display 2 are not obstructed. As a result, the liquid crystal display 2 has enhanced sealing and is more durable and reliable.

Referring to FIG. 2, a liquid crystal display 3 according to the second embodiment of the present invention is shown. The liquid crystal display 3 is similar to the liquid crystal display 2 of the first embodiment, except regarding bumps of a planarization layer 304. This is because the liquid crystal display 3 does not have any protrusions 214 or similar elements. The bumpy upper surface of the planarization layer 304 is formed by a heat flow method. This method is detailed in U.S. Pat. No. 6,342,935, which is incorporated herein by reference.

Referring to FIG. 3, a liquid crystal display 4 according to the third embodiment of the present invention is shown. The liquid crystal display 4 comprises an upper substrate 401, a lower substrate 402, and a liquid crystal layer 408 interposed between the substrates 401, 402. A color filter 416, a transparent electrode 412 and an upper alignment film 410 are disposed on an underside of the upper substrate 401, in that order from top to bottom. A planarization layer 404, a reflection electrode 417 and a lower alignment film 406 are disposed on the lower substrate 402, in that order from bottom to top. An adhesive frame 415 for conglutinating the substrates 401 and 402 is disposed between corresponding edges of inner surfaces of the substrates 401 and 402.

A backlight system (not shown) is disposed under the lower substrate 402. Some parts of the lower substrate 402 directly abut the alignment film 406. At these parts of the lower substrate 402, there are no corresponding adjacent parts of the planarization layer 404 and the reflection electrode 417. These parts of the lower substrate 402 together with the corresponding abutting parts of the alignment film 406 are defined as transmissive portions 440. Because there is no black resin and reflection electrode at the transmissive portions 440, light beams coming from the backlight system can pass through the transmissive portions 440. In addition, the reflection electrode 417 enables utilization of light from the external environment. That is, the liquid crystal display 4 is a transmissive-reflective type LCD, and has numerous indoor and outdoor applications.

The planarization layer 404 with the bumpy upper surface can be formed by employing the above-described heat flow method. Then a metal layer is deposited on the planarization layer 404. The metal layer is then processed to become the reflection electrode 417 with corresponding bumps. The bumps scatter incoming light beams from the external environment, and thus help generate uniform reflection of the light beams.

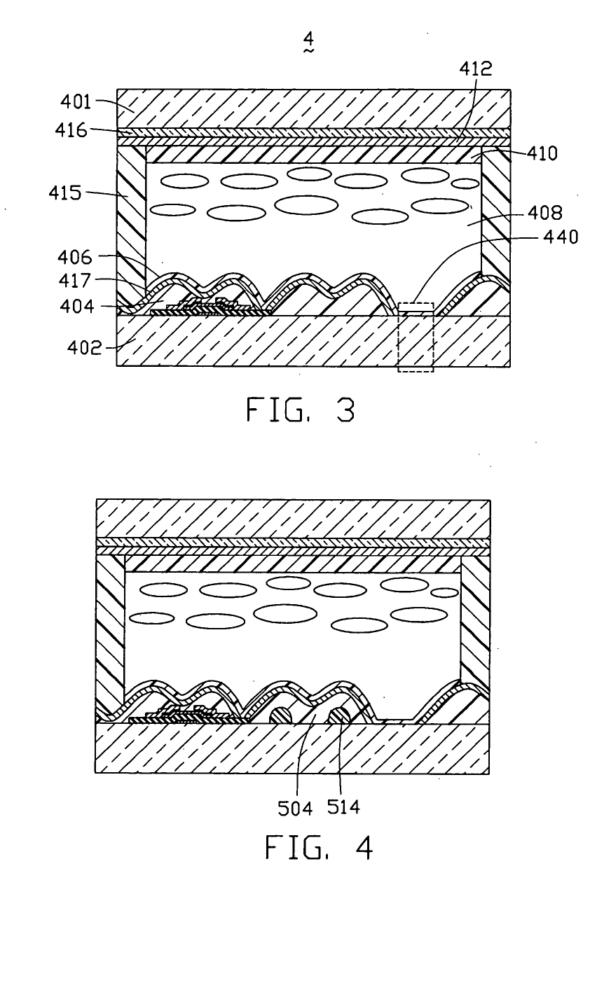

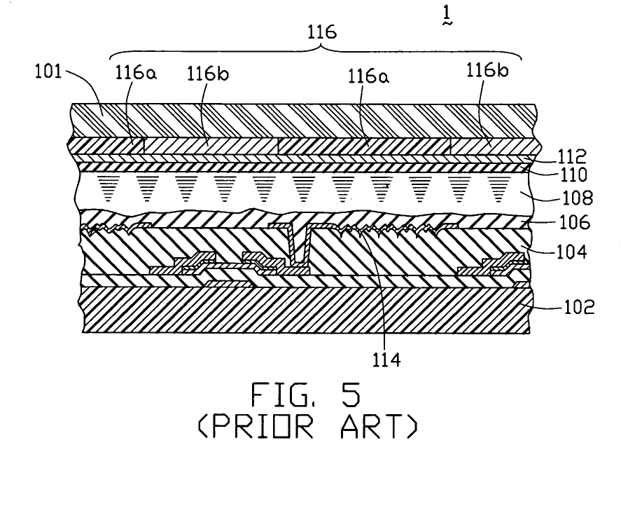

Referring to FIG. 4, a liquid crystal display 5 according to the fourth embodiment of the present invention is shown. The liquid crystal display 5 is similar to the liquid crystal display 4 of the third embodiment, except regarding bumps of a planarization layer 504. The liquid crystal display 5 has protrusions 514. Therefore the bumpy upper surface of the planarization layer 504 is formed due to the protrusions 514.

In each of the liquid crystal displays 3, 4, 5 of the second, third and fourth embodiments, the reflection electrode does not cover the entire planarization layer 304, 404, 504. That is, there are gaps in the reflection electrode, which are known as non-display areas. These non-display areas correspond to gaps between colored sections of the color filter. The planarization layer are made by black resin, and at the vacant areas of the reflection electrodes, the black resin substantial play a role of a black matrix. The planarization layer 204 is made of a black resin. Therefore the planarization layer 304, 404, 504 absorbs light beams leaked from the non-display areas. That is, part of the planarization layer 304, 404, 504 functions like and effectively forms a black matrix. Therefore the liquid crystal display 3, 4, 5 does not need a black matrix combined with the color filter, which reduces costs. Like the liquid crystal display 1, the liquid crystal displays 3, 4, 5 all have the advantages of enhanced sealing and more durability and reliability.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal display, comprising:
an upper substrate;
a lower substrate;
a liquid crystal layer interposed between the upper and lower substrates; and
a planarization layer and a reflection layer disposed on the lower substrate in that order;
wherein the planarization layer has black resin and defines a black matrix.

2. The liquid crystal display as claimed in claim 1, wherein the reflection layer has gaps therein, the gaps define non-display areas, and parts of the planarization layer corresponding to the non-display areas define the black matrix.

3. The liquid crystal display as claimed in claim 2, wherein the reflection electrode has a plurality of bumps.

4. The liquid crystal display as claimed in claim 3, further comprising a plurality of protrusions disposed on the lower substrate for forming the bumps of the reflection electrode.

5. The liquid crystal display as claimed in claim 3, wherein the bumps are formed by a heat flow method.

6. The liquid crystal display as claimed in claim 2, wherein the planarization layer and the reflection electrode cooperatively define transmissive portions for allowing backlight to pass therethrough.

7. The liquid crystal display as claimed in claim 6, further comprising a backlight system disposed under the lower substrate for providing backlight.

8. The liquid crystal display as claimed in claim 7, wherein a plurality of bumps is formed on the reflection electrode.

9. The liquid crystal display as claimed in claim 8, further comprising a plurality of protrusions disposed on the lower substrate for forming the bumps.

10. The liquid crystal display as claimed in claim 8, wherein the bumps are formed by a heat flow method.

11. A transmissive-reflective type liquid crystal display, comprising:
an upper substrate;
a lower substrate;
a liquid crystal layer interposed between the upper and lower substrates;
a backlight system disposed under the lower substrate;
a planarization layer and a reflection layer disposed on the lower substrate in that order and cooperatively defining transmissive portions for allowing backlight to pass therethrough;
wherein the planarization layer further perform the function of a black matrix.

12. A transmissive-reflective type liquid crystal display, comprising:
an upper substrate subassembly facing a user;
a lower substrate subassembly located under the upper substrate subassembly;
a liquid crystal layer interposed between the upper and lower substrate subassemblies; and
no black device being formed in said upper substrate subassembly so as not to obstruct ultraviolet light atop the upper substrate subassembly from vertically entering therethrough; wherein
said ultraviolet light is to solidify a frame which is used to fasten and seal the upper substrate subassembly and said lower substrate subassembly together.
